(19) United States
(12) Patent Application Publication
(10) Pub. No.: US 2002/0050199 A1
(43) Pub. Date: May 2, 2002

(54) Paper cutting apparatus

(76) Inventor: Masashi Takinami, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 09/900,171

(22) Filed: Jul. 9, 2001

(30) Foreign Application Priority Data
Oct. 31, 2000 (JP) 2000-331855

(51) Int. Cl. B23D 19/06; B26D 7/06; B26D 1/24

(52) U.S. Cl. 83/425.3; 83/493; 83/501

(57) ABSTRACT

A cutting apparatus for cutting a piece of large-sized, printed paper as large as the multiple of a piece of small-sized paper into the multiple number of pieces of small-sized paper each having letters and/or pictures printed thereon such as name cards. The cutting apparatus has two pairs of parallel-arranged rods rotatably supported in its casing. The first pair of parallel-arranged rods has paired sharp blades fixed thereto at a relatively large interval whereas the second pair of parallel-arranged rods has paired sharp blades fixed thereto at a relatively small interval. The two parallel-arranged rods each of the first and second pairs are separated such a predetermined distance as to allow the paired sharp blades to rub circumferentially on each other. A handle is rotatably fixed to the casing, and operatively connected to the two pairs of parallel-arranged rods for turning the paired rods in opposite directions. Two inlets are made in the casing, one close to the first pair of parallel-arranged rods for inserting the pre-cut piece of paper, and the other close to the second pair of parallel-arranged rods for inserting the post-cut piece of paper.

### BACKGROUND OF THE INVENTION

1. Field of the Invention

The present invention relates to a cutting apparatus for cutting a piece of large-sized paper having a plurality of pieces of information printed therein (for example, by means of a personal computer) into a corresponding plurality of pieces of paper each having a piece of information such as visiting cards, post cards, stickers, labels, tickets and the like.

2. Related Arts

Recently visiting cards have been prepared by using personal computers and associated printers; unique visiting cards can be easily prepared at home.

Commercially visiting cards are prepared by printing small-sized pieces of paper one by one in a printing house. In some instances a lot of large-sized pieces of printed paper each having a plurality of pieces of similar information in common are stacked, and then a stack of printed, large-sized pieces of paper are cut into pieces of small-sized pieces of paper each having a piece of same information. Then, extra piece of information in the form of patterns or pictures is printed on each small-sized piece of paper.

In cutting into small-sized pieces the stack of printed, large-sized pieces of paper are fastened as a whole by applying a strong force to each edge of the stack, thereby preventing the stack from being displaced partly and deformed laterally. Again, the plurality of small-sized pieces of paper thus cut is printed one by one to add extra piece of information to the piece of same information already printed. Thus, different kinds of visiting cards result. This method of printing visiting cards causes little or no problem when a large number of visiting cards are prepared, but such printing method cannot be used in printing a small number of visiting cards because its printing efficiency is inhibitably lowered.

A small number of visiting cards can be printed one by one by using a small-sized printer, but this cannot be applied to the multi-color printing of visiting cards because of inhibitably high printing cost. This is the same with the use of personal computers in printing visiting cards. Almost all kinds of personal computers cannot allow associated printers to print card-sized pieces of paper. A large-sized piece of paper, therefore, is used to print same letters and patterns in the form of lattice, and a plurality of such large-sized piece of paper thus printed are stacked and cut into card-sized pieces of paper.

In some instances perforations are formed to be like a lattice pattern on each large-sized piece of printed paper, encircling each piece of information, and visiting cards are provided by tearing the large-sized piece of paper along crosswise perforations.

Recently visiting cards each bearing a picture of one's face at one corner have been used in the hope of giving unforgettable impression to customers. This sort of visiting card requires a time-consuming work, but it can be easily prepared by using personal computers and associated printers. Almost all personal computers have software program for preparing visiting cards installed therein, but such visiting cards prepared by personal computers are not used in business. Several tens to around a hundred visiting cards can be prepared and used. The cause for limiting such cards to a relatively small number is difficulty in cutting numerous pieces of printed paper into precise card shape and size with a small-sized, hand-operated cutting tool, which is apt to allow the pile of pieces of printed paper to be displaced laterally. Therefore, no clear-cut visiting cards result.

An automatic cutting machine is usually unavailable, and perforated pieces of paper are not preferable for use because of less attractive appearance in finished cards. This cutting problem is common in preparation of post cards, stickers, labels, tickets and the like.

### SUMMARY OF THE INVENTION

In view of the above one object of the present invention is to provide a cutting apparatus which is less expensive, and is capable of cutting a large-sized piece of paper into a plurality of small-sized pieces of precise shape and size such as visiting cards. Same signs, patterns or pictures can be easily printed on a large-sized piece of paper by using a personal computer and an associated printer. The cutting apparatus according to the present invention permits such a large-sized piece of paper thus printed to be cut into a plurality of clear-cut pieces of paper, each having same signs or patterns such as visiting cards, post cards, stickers or labels. Each small-sized piece of paper is clear cut as would not have been ever possible by using a small-sized, hand-operated cutting tool. This permits use of personal computers in preparing visiting cards, post cards, stickers or labels, which are of good quality high enough to be used in business.

To attain the above described object a cutting apparatus for cutting a piece of large-sized, printed paper as large as the multiple of a piece of small-sized paper into the multiple number of pieces of small-sized paper each having letters and/or pictures printed thereon such as name cards, is improved according to the present invention in that it comprises: two pairs of parallel-arranged rods rotatably supported in the casing of the cutting apparatus, the first pair of parallel-arranged rods having paired sharp blades fixed thereto at a relatively large interval, the second pair of parallel-arranged rods having paired sharp blades fixed thereto at a relatively small interval, the two parallel-arranged rods each of the first and second pairs being separated such a predetermined distance as to allow the paired sharp blades to rub circumferentially on each other; a handle rotatably fixed to the casing, and operatively connected to said two pairs of parallel-arranged rods for turning the paired rods in opposite directions; and two inlets made in the casing, one close to the first pair of parallel-arranged rods for inserting the pre-cut piece of paper, and the other close to the second pair of parallel-arranged rods for inserting the post-cut piece of paper.

Each of said two inlets may have a feeder for feeding pieces of paper one after another.

The sharp blades on one rod may have springs to push them against their counter sharp blades on the other rod.

The parallel-arranged rods may have rolls of elastic material fixed thereto with their circumferences put in contact with each other.

The cutting apparatus may be so designed that one of the paired sharp blades has a circumferential speed different from the other.

Other objects and advantages of the present invention will be understood from the following description of a cutting apparatus according to one preferred embodiment of the present invention, which is shown in accompanying drawings:

### BRIEF DESCRIPTION OF THE DRAWING

FIG. 1 shows a large-sized piece of paper (Size A4) having ten visiting cards printed thereon;

FIGS. 2(a), 2(b) and 2(c) illustrate how the large-sized piece of paper (Size A4) can be cut into ten visiting cards;

FIG. 3 is a perspective view of a cutting apparatus according to the present invention;

FIG. 4 illustrates the mechanical structure of the cutting apparatus; and

FIG. 5 illustrates a hopper-and-feeder associated with the cutting apparatus.

### DETAILED DESCRIPTION OF PREFERRED EMBODIMENT

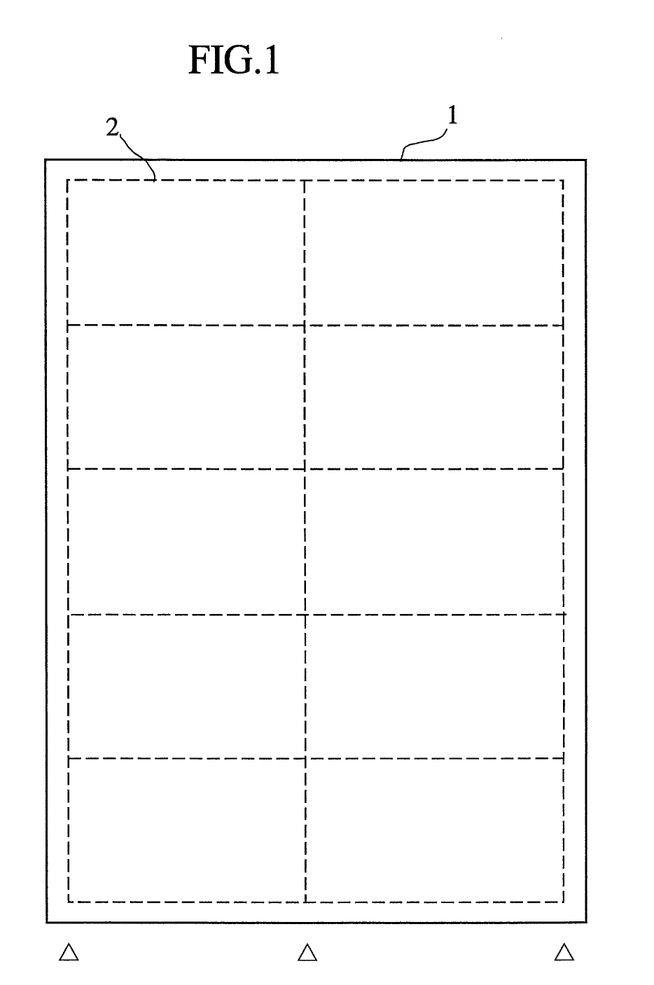

Referring to FIG. 1, a large-sized piece of paper (Size A4: 210 mm×297 mm) 1 has ten visiting cards 2 printed thereon. The large-sized piece of paper 1 is cut along crosswise broken lines into ten visiting cards 2 by using a cutting apparatus according to the present invention. A plurality of pieces of large-sized, printed paper are stacked and inserted in the first inlet opening of the cutting apparatus. Then, the stack of printed paper is put in the hopper of the cutting apparatus, allowing the feeder to feed pieces of paper to the cutter blades one by one. Then, a plurality of resulting pieces of intermediate-sized paper are stacked and inserted in the second inlet opening of the cutting apparatus so that each piece of intermediate-sized paper may be cut into numerous pieces of small-sized paper. In short, each piece of printed, large-sized paper is cut longitudinally, and then laterally to provide clear-cut cards.

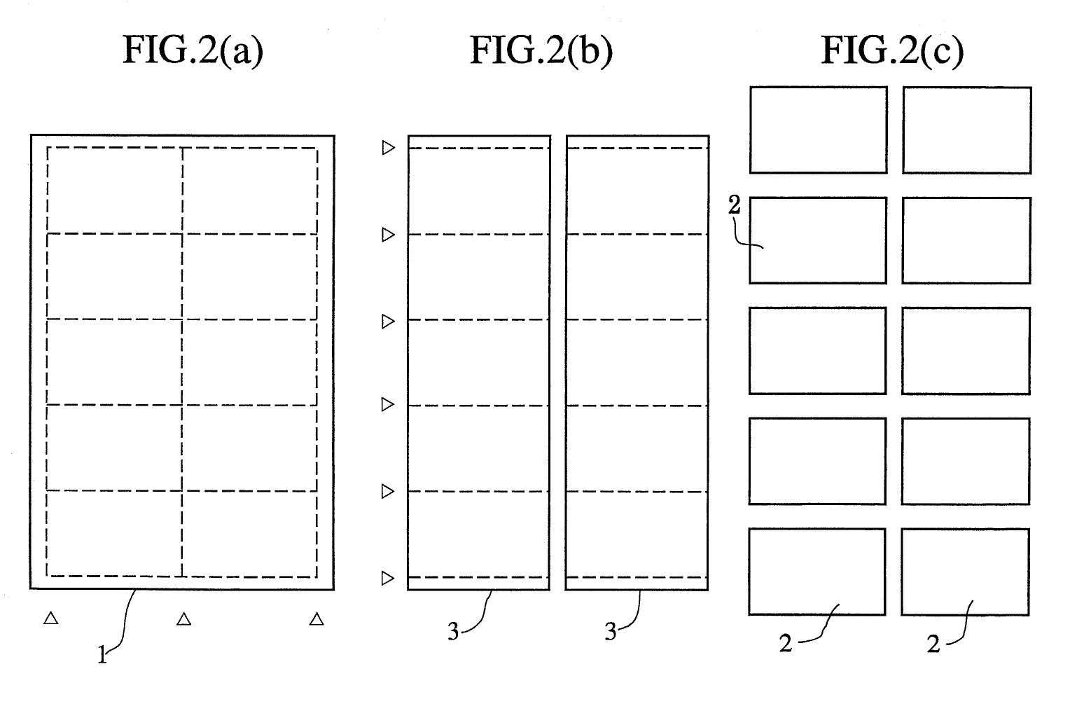

Referring to FIG. 2, the manner in which a large-sized piece of printed paper (Size A4) is divided into ten cards is described in more detail. Referring to FIG. 2(a), the piece of printed paper of Size A4 is cut along three longitudinal broken lines, each marked with a triangle. Then, two pieces of intermediate-sized, printed paper 3 result as shown in FIG. 2(b). Each piece of intermediate-sized, printed paper is cut along six lateral broken lines, each marked with a triangle, also. Thus, five pieces of small-sized, printed paper are prepared, each having same letters and/or patterns. As seen from FIG. 2(c), ten cards or stickers result from a piece of paper of Size A4.

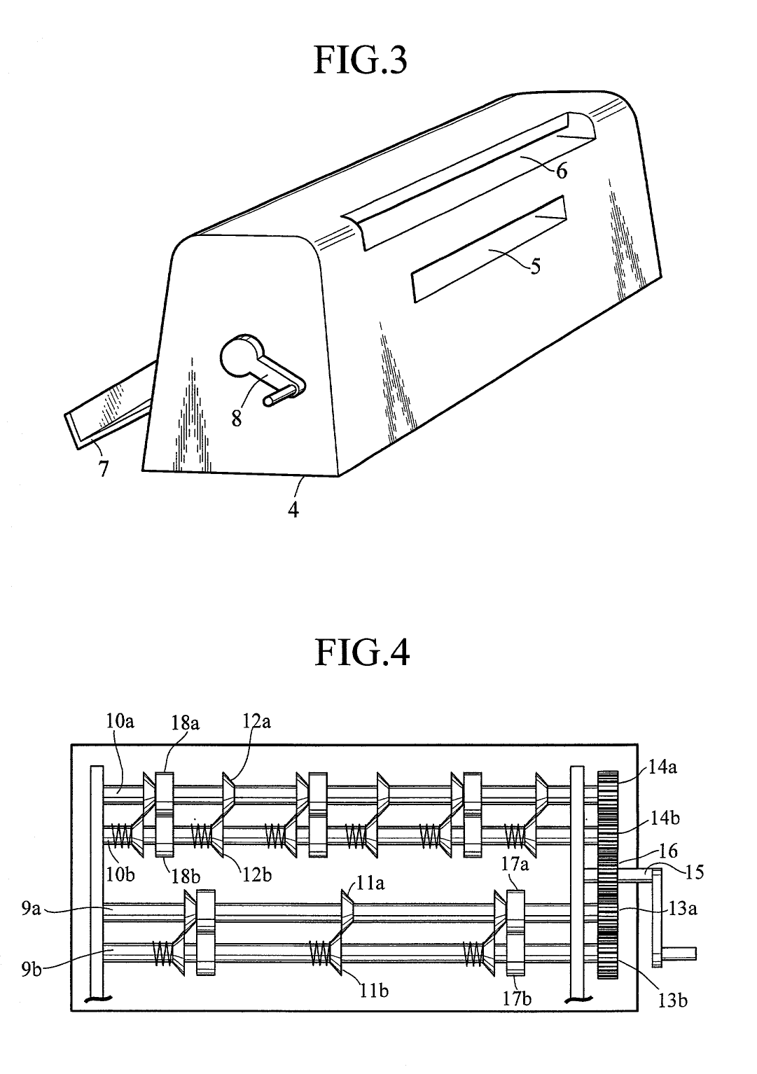

Referring to FIG. 3, a cutting apparatus according to one preferred embodiment has two inlet openings 5 and 6 on its front, and an outlet opening on its rear side. A stopper-and-holder 7 is attached to the outlet opening, and a handle 8 is rotatably fixed to one side of the casing 4. When the handle 8 is rotated, pieces of paper are pulled into the casing one by one, allowing each piece of paper thus drawn to pass through the casing while being cut on the way from the inlet 5 or 6 to the outlet.

Specifically each piece of large-sized, printed paper (FIG. 2(a)) is fed longitudinally from the inlet opening 5, and then, two pieces of intermediate-sized paper 3 (FIG. 2(b)) appear from the outlet opening. Each piece of intermediate-sized paper is fed laterally from the inlet opening 6, and then, five pieces of small-sized paper 2 (FIG. 2(c)) appear from the outlet opening.

Referring to FIG. 4, the cutting apparatus comprises: two pairs of parallel-arranged rods 9a, 9b: 10a, 10b rotatably supported in the casing 4. As shown, the first pair of parallel-arranged rods 9a and 9b have paired sharp blades 11a and 11b fixed thereto at three positions. Specifically, these paired sharp blades 11a and 11b are separated a regular interval equal to the longer side of the small-sized piece of paper 2. Thus, each piece of large-sized, printed paper (FIG. 2(a)) can be cut and divided into two pieces of intermediate-sized paper 3 (FIG. 2(b)). As shown, two parallel-arranged rods 9a and 9b are separated such a predetermined distance as to allow the paired sharp blades 11aand 11b to rub on each other, thus functioning like scissors. Likewise, the second pair of parallel-arranged rods 10a and 10b have paired sharp blades 12a and 12b fixed thereto at six positions. These paired sharp blades 12a and 12b are separated a regular interval equal to the shorter side of the small-sized piece of paper 2. Thus, each piece of intermediate-sized, printed paper (FIG. 2(b)) can be cut and divided into five pieces of small-sized paper or cards 2 (FIG. 2(c)). Each rod 9a, 9b, 10a or 10b has a gear 13a, 13b, 14a or 14b fixed to one end, and these gears of same size are meshed together via an intervening gear 16, which is connected to the handle axle 15.

Thus, the handle 8 is operatively connected to the first and second pairs of parallel-arranged rods 9a, 9b and 10a, 10b for turning the paired rods 9a and 9b or 10a and 10b in opposite directions at same speed. Here, it should be noted that if one of the paired sharp blades has a circumferential speed different from the other, the sharp blades can slip on each other while rotating, thereby preventing the cutting quality from lowering. The parallel-arranged rods 9a and 9b have rolls of elastic material 17a and 17b fixed thereto with their circumferences put in contact with each other. These rolls 17a and 17b are positioned close to the paired sharp blades 11a and 11b so that a piece of large-sized paper 1 may be pinched and transferred by the rolls 17a and 17b on the way from the feeder to the outlet opening; the paired sharp blades 11a and 11b has little or no power to transport the piece of paper.

Likewise, the parallel-arranged rods 10a and 10b have rolls of elastic material 18a and 18b fixed thereto. These rolls 18a and 18b are positioned close to the paired sharp blades 12a and 12b so that an intermediate-sized piece of paper 3 may be pinched and transferred by the rolls 18a and 18b on the way from the feeder to the outlet opening.

The sharp blades 11a and 11b are put on each other, leaving no space therebetween. The sharp blade 11b on the rod 9b has a coiled spring to push it against the counter sharp blade 11a, thereby removing any intervening space therebetween, which would appear if the sharp blades are worn on their confronting sides. Likewise, the sharp blade 12b on the rod 10b has a coiled spring to push it against the counter sharp blade 12a. With this arrangement it is assured that the paired sharp blades 11a, 11b or 12a, 12b be put close to each other all the time, and that the sharp blades cut well.

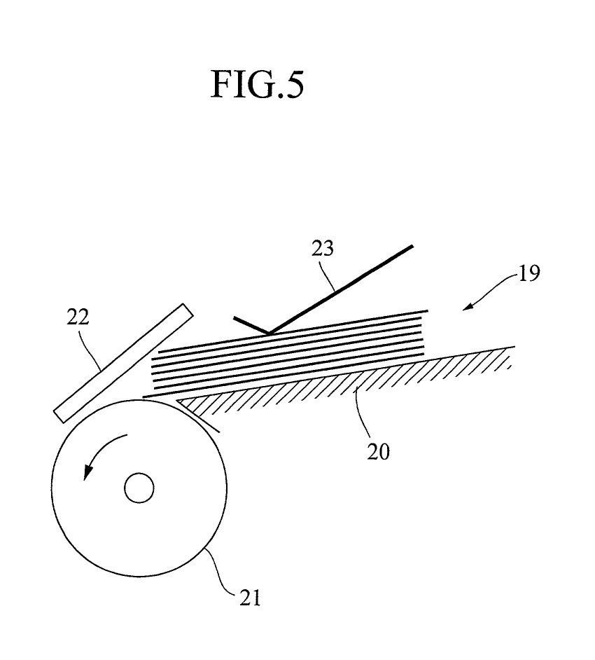

A plurality of pieces of large-sized paper 1 are inserted in the inlet opening 5 one after another by hand to allow the sharp blades 11a and 11b to cut each piece of large-sized paper 1 into two pieces of intermediate-sized paper. Then, the pieces of intermediate-sized paper 3 are inserted in the inlet opening 6 one after another by hand to allow the sharp blades 12a and 12b to cut each piece of intermediate-sized paper 3 into five pieces of small-sized paper. Each of the two inlet openings 5 and 6 may have a hopper-and-feeder for storing a stack of pieces of paper and for feeding pieces of paper one after another, as seen from FIG. 5.

According to the gear mechanism of the cutting apparatus as shown in FIG. 4, the handle axle 15 rotates in the opposite direction comparing the case of cutting the large-sized piece of paper I into the pieces of intermediate-sized paper 3 and the case of cutting the pieces of intermediate-sized paper 3 into the visiting cards 2, 2. An intermediate gear may be provided between the gears 16 and 13a or 14b so that the handle axle 15 rotates in the same direction in the above both cases.

As seen from FIG. 5, the hopper section 19 has a rubber roll 21 positioned on the downstream side of the bottom 20, and an oblique rubber plate 22 is tangential to the rubber roll 21. A stack of pieces of paper of Size A4 is put on the bottom 20, and is pushed against the bottom 20 with a spring plate 23.

When the rubber roll 21 is rotated counter-clockwise by the handle 8, the lowermost piece of paper of Size A4 is pulled out from the stack. For the purpose the friction coefficient N₁ of the rubber roll 21, the friction coefficient N₂ of the rubber plate 22 and the friction coefficient N₃ of the piece of paper are selected to meet the following relation:

N₁>N₂>N₃

As is apparent from the above, a cutting apparatus according to the present invention is simple in structure, easy in operation, and least expensive, still assuring that pieces of paper can be cut into divisional pieces which are clear cut as anyone ever could see when cutting with a small-sized, hand-operated cutting tool. This permits use of personal computers and associated printers in preparing high-quality of visiting cards, post cards, stickers or labels at home. The paired sharp blades are urged to each other by an associated spring to assure that they cut well all the time, not being adversely influenced by wear.

What is claimed is:

1. A cutting apparatus for cutting a piece of large-sized, printed paper as large as multiple of a piece of small-sized paper into multiple number of pieces of small-sized paper each having letters and/or pictures printed thereon such as name cards, characterized in that it comprises: two pairs of parallel-arranged rods rotatably supported in a casing of the cutting apparatus, the first pair of parallel-arranged rods having paired sharp blades fixed thereto at a relatively large interval, the second pair of parallel-arranged rods having paired sharp blades fixed thereto at a relatively small interval, the two parallel-arranged rods each of the first and second pairs being separated such a predetermined distance as to allow the paired sharp blades to rub circumferentially on each other; a handle rotatably fixed to the casing, and operatively connected to said two pairs of parallel-arranged rods for turning the paired rods in opposite directions; and two inlets made in the casing, one close to the first pair of parallel-arranged rods for inserting the pre-cut piece of paper, and the other close to the second pair of parallel-arranged rods for inserting the post-cut piece of paper.

2. A cutting apparatus according to claim 1, wherein each of said two inlets has a feeder for feeding pieces of paper one after another.

3. A cutting apparatus according to claim 1, wherein the sharp blades on one rod have springs to push them against their counter sharp blades on the other rod.

4. A cutting apparatus according to claim 3, wherein the parallel-arranged rods have rolls of elastic material fixed thereto with their circumferences put in contact with each other.

5. A cutting apparatus according to claim 4, wherein the cutting apparatus is so designed that one of the paired sharp blades has a circumferential speed different from the other.
